(19) United States
(12) Patent Application Publication
(10) Pub. No.: US 2023/0082351 A1
(43) Pub. Date: Mar. 16, 2023

(54) Dye Printing Treatment Liquid Composition, Composition Set, Printing Method, And Ink Jet Printing Method

(71) Applicant: SEIKO EPSON CORPORATION, Tokyo (JP)

(72) Inventor: Kazuki SHIMURA, Shiojiri (JP)

(21) Appl. No.: 17/898,771

(22) Filed: Aug. 30, 2022

(30) Foreign Application Priority Data
Aug. 31, 2021 (JP) 2021-140883

(51) Int. Cl. C09D 11/54; C09D 11/104; C09D 11/033; C09D 11/037; C09D 11/328; C09D 11/40; D06P 5/30; D06P 5/00; D06P 5/28; D06P 1/52; D06P 1/54; B41M 5/00

(52) U.S. Cl. CPC C09D 11/54; C09D 11/104; C09D 11/033; C09D 11/037; C09D 11/328; C09D 11/40; D06P 5/30; D06P 5/002; D06P 5/005; D06P 1/5271; D06P 1/54; B41M 5/0011; D06P 3/60

(57) ABSTRACT

A dye printing treatment liquid composition to be adhered to a cloth, includes: a polyester resin having a glass transition temperature of 40° C. or more; a cross-linking agent; and water, and the cloth contains fibers which have hydroxy groups.

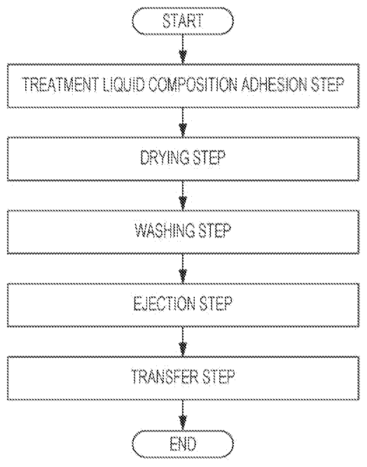

The present application is based on, and claims priority from JP Application Serial Number 2021-140883, filed Aug. 31, 2021, the disclosure of which is hereby incorporated by reference herein in its entirety.

### BACKGROUND

### 1. Technical Field

The present disclosure relates to a dye printing treatment liquid composition, a composition set, a printing method, and an ink jet printing method.

### 2. Related Art

Heretofore, there has been known a technique in which when a printed matter is manufactured by printing a cloth with a colorant, in order to improve a color development property of the colorant and a fastness, a pre-treatment is performed on the cloth using a treatment liquid. As the technique described above, for example, a technique disclosed in JP-A-2009-249773 in which a pre-treatment liquid formed from a water-based composition is adhered to a polyester cloth has been known.

However, JP-A-2009-249773 has disclosed a technique to be performed on a polyester cloth, and printing to be performed on a cloth formed from natural fibers has not been described. Unlike the cloth formed from natural fibers, a polyester cloth can be printed with a dye even if a pre-treatment liquid is not used, and in general, a dyed portion to be obtained has a color development property and a fastness. However, even when the pre-treatment liquid disclosed in JP-A-2009-249773 is used on the cloth formed from natural fibers, there has been a problem in that a dyed portion having a discoloration resistance together with sufficient color development property and fastness is difficult to obtain by the pre-treatment liquid described above.

### SUMMARY

According to one aspect of the present disclosure, there is provided a dye printing treatment liquid composition to be adhered to a cloth, the treatment liquid composition comprising: a polyester resin having a glass transition temperature of 40° C. or more, a cross-linking agent, and water, and the cloth contains fibers which have hydroxy groups.

### BRIEF DESCRIPTION OF THE DRAWINGS

FIGURE is a flowchart showing one example of an indirect printing recording method of this embodiment.

### DESCRIPTION OF EXEMPLARY EMBODIMENTS

Hereinafter, although an embodiment (hereinafter, referred to as “this embodiment”) of the present disclosure will be described in detail, the present disclosure is not limited thereto and may be variously changed and/or modified without departing from the scope of the present disclosure.

### 1. Dye Printing Treatment Liquid Composition

A dye printing treatment liquid composition (hereinafter, referred to as “treatment liquid composition” in some cases) of this embodiment is used to be adhered to a cloth containing fibers which have hydroxy groups before dye printing is performed. The treatment liquid composition includes a polyester resin having a glass transition temperature of 40° C. or more, a cross-linking agent, and water.

According to this embodiment, when the treatment liquid composition is adhered in advance to the cloth containing fibers which have hydroxy groups, and dye printing is performed on the cloth to which the treatment liquid composition is adhered, a printed matter having sufficient color development property, discoloration resistance of a dyed portion with time, and fastness, such as abrasion resistance, can be easily obtained.

Although the reasons the excellent effect as described above can be obtained by this embodiment have not been clearly understood, the present inventors believe as follows.

That is, in general, an ink containing a dispersive dye or the like to be used for printing has a low affinity to a cloth, such as cotton, containing fibers which have hydroxy groups, and dye printing is difficult to perform thereon. On the other hand, the ink containing a dispersive dye or the like is likely to dye a polyester resin by a hydrogen bond with a carboxy group and/or a non-covalent bond which includes a π-π interaction with a hydrophobic portion, such as a phenyl group, and a van der Waals force in the structure of the polyester resin. In addition, since having a high affinity to a cloth containing fibers, a polyester resin is able to exist on the cloth. Hence, when a polyester resin is adhered to the cloth using a treatment agent composition, a dyeing property of the ink containing a dispersive dye or the like can be imparted to fibers, such as cotton, which have hydroxy groups.

However, since a rate of hydrophobic portions in the structure of a polyester resin is small, and since a dispersive dye is not likely to dye an amorphous portion, when crystallization with a cloth is not advanced, the polyester resin is not likely to be dyed, and a dyed portion is liable to be discolored with time. On the other hand, the treatment liquid composition of this embodiment includes a polyester resin having a glass transition temperature of 40° C. or more. Accordingly, the polyester resin is able to be crystallized on a cloth, and the dispersive dye is able to apply an ink to a crystalline portion of the polyester resin. As a result, according to this embodiment, a sufficient color development property can be obtained, and in addition, an excellent discoloration resistance of a dyed portion with time can also be obtained.

In addition, the polyester resin is only adhered to the cloth and is not bonded thereto. Hence, even when an excellent discoloration resistance can be obtained together with a sufficient color development property using a polyester resin having a glass transition temperature of 40° C. or more, the fastness, such as an abrasion resistance, is not sufficient. However, since the treatment liquid composition of this embodiment includes a cross-linking agent, the polyester resin and the cloth can be bonded to each other. Hence, according to this embodiment, it is believed that a dyed portion having not only a sufficient color development property and an excellent discoloration resistance but also an excellent fastness can be obtained. However, the reasons are not limited to those described above.

Next, the components included in the treatment liquid composition will be described, and the cloth will be described later.

### 1.1. Polyester Resin Having Glass Transition Temperature of 40° C. or More

The treatment liquid composition includes a polyester resin having a glass transition temperature of 40° C. or more.

In the treatment liquid composition, since the polyester resin is included, a dyed portion having a sufficient color development property and an excellent discoloration resistance can be obtained.

The polyester resin is not particularly limited as long as having a glass transition temperature of 40° C. or more. In addition, in this embodiment, the glass transition temperature of the polyester resin may be measured by a differential scanning calorimeter (hereinafter, referred to as “DSC” in some cases).

When printing is performed on the cloth to which the treatment liquid composition is adhered, since a printed matter having more sufficient color development property, discoloration resistance, and fastness can be obtained, the glass transition temperature of the polyester resin is preferably 50° C. or more. An upper limit of the glass transition temperature described above is for example, 180° C. or less and may also be 150° C. or less.

As the polyester resin, for example, a constituent unit derived from a polycarboxylic acid and a constituent unit derived from a polyalcohol unit are included.

As the polycarboxylic acid, for example, there may be mentioned terephthalic acid, isophthalic acid, ortho-phthalic acid, a phthalic acid, 4,4′-diphenyldicarboxylic acid, 2,5-naphthalene dicarboxylic acid, 1,5-naphthalene dicarboxylic acid, 2,6-naphthalene dicarboxylic acid, 2,7-naphthalene dicarboxylic acid, 1,4-cyclohexane dicarboxylic acid, 2-potassium sulfoterephthalate, 5-sodium sulfoisophthalate, adipic acid, azelaic acid, sebacic acid, dodecanedicarboxylic acid, glutaric acid, succinic acid, trimellitic acid, trimesic acid, pyromellitic acid, trimellitic anhydride, phthalic anhydride, succinic anhydride, p-hydroxybenzoic acid, or a salt one of those mentioned above. As the salt, for example, a potassium salt, a sodium salt, a calcium salt, or a magnesium salt may be mentioned.

As the polyalcohol, for example, there may be mentioned ethylene glycol, 1,2-propylene glycol, 1,3-propylene glycol, 1,3-butylene glycol, 1,4-butanediol, 1,6-hexanediol, 2-methyl-1,5-pentanediol, neopentyl glycol, 1,4-cyclohexanedimethanol, p-xylylene glycol, a bisphenol A-ethylene glycol adduct, diethylene glycol, triethylene glycol, a polyethylene glycol, a polypropylene glycol, a polytetramethylene glycol, a polytetramethylene oxide glycol, dimethylol propionic acid, glycerin, trimethylolpropane, sodium dimethylolethyl sulfonate, potassium dimethylolethyl sulfonate, or potassium dimethylol propionate.

The polyester resin preferably includes a hydroxy group, a carboxy group, a sulfonic acid group, and/or a sodium salt of one of those mentioned above. One or at least two of those groups mentioned above may be included in the polyester resin.

A sulfonic acid group-containing polyester resin includes, for example, a constituent unit derived from a polycarboxylic acid, a constituent unit derived from a polyalcohol, and a constituent unit derived from a sulfonic acid-containing aromatic monomer.

As the sulfonic acid-containing aromatic monomer, for example, there may be mentioned 5-sulfoisophthalic acid, sulfoterephthalic acid, 4-sulfophalic acid, 4-sulfonaphthalene-2,7-dicarboxylic acid, 4-sulfo-1,8-naphthalene dicarboxylic anhydride, or a salt of one of those mentioned above. As the salt, the salts described above may be mentioned for reference, and the sodium salt is preferable.

Since including at least one of the groups described above, the polyester resin is able to preferably react with the cross-linking agent, and adhesion to the cloth containing fibers which have hydroxy groups can be improved. Hence, a printed matter having even more sufficient color development property, discoloration resistance, and fastness can be obtained.

Since a more sufficient color development property and a more excellent discoloration resistance can be obtained, the polyester resin preferably includes a hydrophobic portion, such as an aromatic group, in its structure.

The polyester resin can be synthesized, for example, using a general polycondensation reaction by appropriately selecting at least one of each of the polycarboxylic acids, the polyalcohols, and if needed, the sulfonic acid-containing aromatic monomers.

As the polyester resin described above, a commercially available product may also be used. As the commercially available product, for example, there may be mentioned Plascoat (registered trademark) Z-221, Z-446, Z-561, Z-565, RZ-570, Z-592, Z-687, Z-690, Z-730, Z-760, RZ-105, RZ-570, or RZ-760 (trade name, manufactured by Goo Chemical Co., Ltd.); or Vylonal (registered trademark) MD-1200, MD-1500, or MD-2000 (trade name, manufactured by Toyobo Co., Ltd.).

As the polyester resin, one polyester resin may be used alone, or at least two types thereof may be used in combination.

Since a printed matter having more sufficient color development property, discoloration resistance, and fastness can be obtained, a content of the polyester resin with respect to a total mass of the treatment liquid composition is preferably 0.5 to 12.5 percent by mass on a solid content basis. Since a printed matter having a more excellent fastness together with more sufficient color development property and discoloration resistance can be obtained, the content of the polyester resin with respect to the total mass of the treatment liquid composition is more preferably 1.5 to 8.0 percent by mass on a solid content basis. Since a printed matter having a preferable texture together with more sufficient color development property, discoloration resistance, and fastness can be obtained, the content of the polyester resin with respect to the total mass of the treatment liquid composition is preferably 1.0 to 6.0 percent by mass on a solid content basis. Since a printed matter having a more preferable texture together with more sufficient color development property, discoloration resistance, and fastness can be obtained, the content of the polyester resin with respect to the total mass of the treatment liquid composition is even more preferably 1.5 to 4.0 percent by mass on a solid content basis.

### 1.2. Cross-Linking Agent

The treatment liquid composition includes a cross-linking agent.

Since the cross-linking agent is included in the treatment liquid composition, a cross-linking property can be imparted, and the polyester resin, the dye, and the cloth can be bonded to each other. Hence, while having a sufficient color development property and an excellent discoloration resistance, a dyed portion also having an excellent fastness can be obtained.

The cross-linking agent may be appropriately selected from known cross-linking agents, and either a cross-linking agent to start a cross-linking reaction at ordinary temperature or a cross-linking agent to start a cross-linking reaction by heat may be used. As the cross-linking agent described above, for example, there may be mentioned a cross-linking agent having a self cross-linking property, a compound having a plurality of functional groups in its molecule to react with unsaturated carboxylic acid components, or a metal having a plurality of coordination positions.

Since a printed matter having more sufficient color development property, discoloration resistance, and fastness can be obtained, as the cross-linking agent, for example, a compound including an isocyanate group and/or an oxazoline group is preferable.

As an isocyanate group-containing cross-linking agent, for example, a water dispersible (block)polyisocyanate may be mentioned. In addition, the (block) isocyanate indicates a polyisocyanate and/or a block polyisocyanate.

As the water dispersible polyisocyanate, for example, there may be mentioned a polyisocyanate which has a hydrophilic property imparted by a polyethylene oxide chain and which is dispersed in water by an anionic dispersant or a nonionic dispersant.

As the polyisocyanate, for example, there may be mentioned a diisocyanate, such as hexamethylene diisocyanate or isophoronediisocyanate; or a polyisocyanate derivative (modified product), such as a trimethylolpropane adduct, a burette form, or an isocyanurate form, of the diisocyanate mentioned above. Those polyisocyanates may be used alone, or at least two types thereof may be used in combination.

The water dispersible block polyisocyanate is a compound in which an isocyanate group of a water dispersible polyisocyanate is blocked with a blocking agent. As the blocking agent, for example, there may be mentioned diethyl malonate, ethyl acetoacetate, ε-caprolactam, butanone oxime, cyclohexane oxime, 1,2,4-triazole, dimethyl-1,2,4-triazole, 3,5-dimethyl pyrazole, or imidazole. Those blocking agents may be used alone, or at least two types thereof may be used in combination.

As the isocyanate group-containing cross-linking agent described above, a commercially available product may also be used. As the commercially available product, for example, there may be mentioned Fixer #100ECO, #104EA, #220, 70ECO, #70, #410, or #400 (trade name, manufactured by Murayama Chemical Laboratory Co., Ltd.); or Elastron (registered trademark) BN-11, BN-27, BN-69, or BN-77 (trade name, manufactured by DKS Co., Ltd.).

As the oxazoline group-containing cross-linking agent, for example, a compound having at least two oxazoline groups in its molecule may be mentioned. As the oxazoline group-containing compound described above, for example, there may be mentioned 2,2′-bis(2-oxazoline), 2,2′-methylene-bis(2-oxazoline), 2,2′-ethylene-bis(2-oxazoline), 2,2′-trimethylene-bis(2-oxazoline), 2,2′-tetramethylene-bis(2-oxazoline), 2,2′-hexamethylene-bis(2-oxazoline), 2,2′-octamethylene-bis(2-oxazoline), 2,2′-ethylene-bis(4,4′-dimethyl-2-oxazoline), 2,2′-p-phenylene-bis(2-oxazoline), 2,2′-m-phenylene-bis(2-oxazoline), 2,2′-m-phenylene-bis(4,4′-dimethyl-2-oxazoline), bis(2-oxazolinyl cyclohexane)sulfide, bis(2-oxazolinyl norbornane)sulfide, or an oxazoline ring-containing polymer. Those oxazoline group-containing compounds may be used alone, or at least two types thereof may be used in combination.

Since the polyester resin, the dye, and the cloth can be more tightly bonded to each other, and a dyed portion having a more excellent fastness can be obtained, as the oxazoline group-containing compound, a water-soluble oxazoline group-containing compound is preferable.

As the oxazoline group-containing cross-linking agent described above, a commercially available product may also be used. As the commercially available product, for example, Epocros (registered trademark) K-2010, K-2020, K-2030, K-2035E, WS-300, WS-500, or WS-700 (trade name, manufactured by Nippon Shokubai Co., Ltd.) may be mentioned.

The cross-linking agents may be used alone, or at least two types thereof may be used in combination.

Since a printed matter having more sufficient color development property, discoloration resistance, and fastness can be obtained, a content of the cross-linking agent with respect to the total mass of the treatment liquid composition is preferably 0.1 to 10.0 percent by mass on a solid content basis.

Since a printed matter having more sufficient color development property, discoloration resistance, and fastness can be obtained, a mass ratio of the polyester resin to the cross-linking agent (polyester resin:cross-linking agent) is preferably 1:0.01 to 1:1.2. Since a printed matter having a preferable texture together with more sufficient color development property, discoloration resistance, and fastness can be obtained, the mass ratio of the polyester resin to the cross-linking agent (polyester resin:cross-linking agent) is preferably 1:0.05 to 1:0.70. In addition, when the polyester resin or the cross-linking agent is an emulsion form or the like, the mass ratio is calculated on a solid content basis.

### 1.3. Water

The treatment liquid composition includes water.

After the treatment liquid composition is adhered to the cloth, the water is evaporated and scattered by drying. As the water, for example, there may be mentioned pure water, such as ion exchange water, ultrafiltration water, reverse osmosis water, or distilled water, or water, such as ultrapure water, in which ionic impurities are removed as much as possible. In addition, when the treatment liquid composition is stored for a long time, since generation of fungi and bacteria can be suppressed, water sterilized by UV radiation, addition of hydrogen peroxide, or the like is preferably used.

A content of the water with respect to the total mass of the treatment liquid composition is preferably 30 to 98 percent by mass, more preferably 35 to 96 percent by mass, and further preferably 40 to 94 percent by mass. When the content of the water is set in the range described above, while an increase in viscosity of the treatment liquid is suppressed, workability when the treatment liquid is adhered to the cloth and a drying property after the adhesion of the treatment liquid can be improved.

Since a higher affinity to the cloth containing fibers which have hydroxy groups and a higher safety can be obtained, the treatment liquid composition is preferably a water-based treatment liquid composition. In addition, in this embodiment, the “water-based” indicates that the content of the water with respect to the total mass of the composition is 30 percent by mass or more.

### 1.4. Other Components

The treatment liquid composition may also include various types of additives, such as a surfactant, a solubilizing agent, a viscosity adjuster, a pH adjuster, an antioxidant, an antiseptic agent, a fungicide, a corrosion inhibitor, and/or a chelating agent.

The additives may be used alone, or at least two types thereof may be used in combination.

A content of each of the additives with respect to the total mass of the treatment liquid composition is, for example, approximately 0.01 to 5.0 percent by mass.

### 1.5. Preparation Method of Treatment Liquid Composition

The treatment liquid composition may be prepared such that after the components are mixed together in an arbitrary order, impurities and foreign materials are removed, if needed, by filtration or the like. As a mixing method of the components, there may be used a method in which after the components are sequentially charged in a container equipped with a stirring device, such as a mechanical stirrer or a magnetic stirrer, stirring and mixing are performed. As a filtration method, for example, centrifugal filtration or filter filtration may be mentioned.

### 1.6. Physical Properties of Treatment Liquid Composition

Physical properties of the treatment liquid composition are arbitrarily adjusted by the type of cloth, an adhesion method to the cloth, that is, the application method to the cloth, and the like. The application method of the treatment liquid composition will be described later.

### 1.6.1. Viscosity

A viscosity of the treatment liquid composition at 20° C. is preferably set to 1.5 to 100 mPa·s. Since the viscosity of the treatment liquid is set in the range described above, when the treatment liquid composition is adhered to the cloth, coating properties, such as spreadability, of the treatment liquid, can be improved.

In addition, the viscosity of the treatment liquid composition is measured, for example, using a viscoelastic tester MCR-300 (manufactured by Pysica). In particular, after a temperature of the treatment liquid composition is controlled to 20° C., the viscosity thereof can be measured by reading a shear viscosity (mPa·s) at a shear rate of 200 (1/s).

### 1.6.2. Surface Tension

A surface tension of the treatment liquid composition at 25° C. is preferably set to 30 to 50 mN/m. Since the surface tension of the treatment liquid composition at 25° C. is set in the range described above, appropriate wettability to and permeability in the cloth can be obtained. In addition, since the treatment liquid composition is likely to be uniformly absorbed in the cloth, a difference in adhesion amount to be generated when the treatment liquid composition is applied, that is, generation of coating irregularity, can be suppressed.

In addition, the surface tension of the treatment liquid composition may be measured, for example, using an automatic surface tensiometer CBVP-Z (manufactured by Kyowa Interface Science Co., Ltd.). In particular, in an environment at 25° C., the measurement can be performed in a manner such that a surface tension when a platinum plate is wetted with the treatment liquid composition is read.

### 2. Ink Jet Ink Composition

An ink jet ink composition (hereinafter, referred to as “ink composition” in some cases) is used to manufacture a printed matter by printing the cloth to which the treatment liquid composition of this embodiment is adhered. Next, the ink composition will be described.

The ink composition according to this embodiment includes a dispersive dye and water.

### 2.1. Dispersive Dye

Since an excellent color development property can be obtained on the cloth to which the treatment liquid composition is adhered, the ink composition includes a dispersive dye as the dye. The dispersive dye is generally in the form of particles and is a colorant to be dispersed in a dispersion medium by a dispersant. In addition, the dispersive dye is, in general, a nonionic dye having at least one hydrophilic group and at least one appropriate polar group. The dispersive dye may be used alone, or at least two types thereof may be used in combination.

As the dispersive dye, for example, there may be mentioned C.I. Disperse Yellow, C.I. Disperse Red, C.I. Disperse Blue, C.I. Disperse Orange, C.I. Disperse Violet, C.I. Disperse Green, C.I. Disperse Brown, or C.I. Disperse Black.

Among those mentioned above, as the disperse dye, a sublimation dye is preferable. In this case, the “sublimation dye” indicates a dye having a sublimation property when being heated.

As the sublimation dye described above, in particular, for example, there may be mentioned C.I. Disperse Yellow 3, 7, 8, 23, 39, 51, 54, 60, 71, or 86; C.I. Disperse Orange 1, 1:1, 5, 20, 25, 25:1, 33, 56, or 76; C.I. Disperse Brown 2; C.I. Disperse Red 11, 50, 53, 55, 55:1, 59, 60, 65, 70, 75, 93, 146, 158, 190, 190:1, 207, 239, or 240; C.I. Vat Red 41; C.I. Disperse Violet 8, 17, 23, 27, 28, 29, 36, or 57; C.I. Disperse Blue 14, 19, 26, 26:1, 35, 55, 56, 58, 64, 64:1, 72, 72:1, 81, 81:1, 91, 95, 108, 131, 141, 145, or 359; or C.I. Solvent Blue 36, 63, 105, or 111.

In this embodiment, since a more preferable dyeing property can be obtained to the cloth to which the treatment liquid composition is adhered, and a printed matter having a sufficient color development property can be obtained, a cyan dye, a red dye, and a yellow dye are preferable. Since a further preferable dyeing property can be obtained, and a printed matter having a sufficient color development property can be obtained, C.I. Disperse Blue 359 is more preferable as the cyan dye, C.I. Disperse Red 60 is more preferable as the red dye, and C.I. Disperse Yellow 54 is more preferable as the yellow dye.

In order to more effectively and reliably obtain the operational effect of this embodiment, a content of the colorant with respect to a total mass of the ink composition is preferably 0.05 to 20 percent by mass.

### 2.2. Water

The ink composition includes water.

As the water, the water included in the above treatment liquid composition and a preferable form thereof may be mentioned for reference.

In order to more effectively and reliably obtain the operational effect of this embodiment, a content of the water with respect to the total mass of the ink composition is preferably 30 to 80 percent by mass.

### 2.3. Dispersant

The ink composition may include a dispersant.

When the ink composition includes a dispersant, a dispersion property of the dispersive dye is improved, and a clogging resistance of the ink composition is improved. As the dispersant, for example, a sodium naphthalene sulfonate/formalin condensate or a resin may be mentioned. The sodium naphthalene sulfonate/formalin condensate is a compound obtained by formalin condensation of a sulfonated compound having a naphthalene ring in its molecule or a salt thereof. The dispersant may be used alone, or at least two types thereof may be used in combination.

Since a more preferable dispersion property is obtained, as the dispersant, a resin is preferably included. As the resin, for example, there may be mentioned an urethane-based resin, a styrene-acrylic-based resin, an acrylic-based resin, a fluorene-based resin, a polyolefin-based resin, a rosin modified resin, a terpene-based resin, a polyester-based resin, a polyamide-based resin, an epoxy-based resin, a vinyl chloride-based resin, a vinyl chloride-vinyl acetate copolymer, or an ethylene-vinyl acetate-based resin. Among those mentioned above, since the clogging resistance is excellent, as the resin, an urethane-based resin or a styrene-acrylic-based resin is preferable, and a styrene-acrylic-based resin is more preferable.

The urethane-based resin is not particularly limited as long as being a resin having an urethane bond in its molecule. As the urethane-based resin, for example, a polyether type urethane resin having an ether bond in its main chain besides an urethane bond, a polyester type urethane resin having an ester bond in its main chain besides an urethane bond, or a polycarbonate type urethane resin having a carbonate bond in its main chain besides an urethane bond may be mentioned. The urethane-based resin may be used alone, or at least two types thereof may be used in combination.

As the urethane-based resin, a commercially available product may also be used. As the commercially available product, for example, there may be mentioned Takelac (registered trademark) W6110 (trade name) manufactured by Mitsui Chemicals Inc.; Acrit (registered trademark) WBR-022U (trade name) manufactured by Taisei Fine Chemical Co., Ltd.; Permarin (registered trademark) UX-368T (trade name), Uprene (registered trademark) UXA-307 (trade name), or U-coat (registered trademark) UWS-145 (trade name) manufactured by Sanyo Chemical Industries, Ltd.; or Solsperse (registered trademark) 47000 (trade name) manufactured by The Lubrizol Corporation.

As the styrene-acrylic-based resin, for example, there may be mentioned a styrene-acrylic acid copolymer, a styrene-methacrylic acid copolymer, a styrene-methacrylic acid-acrylic acid ester copolymer, a styrene-α-methyl styrene-acrylic acid copolymer, or a styrene-α-methyl styrene-acrylic acid-acrylic acid ester copolymer. Those copolymers may have any form selected from the group consisting of a random copolymer, a block copolymer, an alternate copolymer, and a graft copolymer.

As the styrene-acrylic-based resin, a commercially available product may also be used. As the commercially available product, for example, there may be mentioned Joncryl (registered trademark) 67 (trade name) manufactured by BASF Japan, or Solsperse (registered trademark) 43000 (trade name) manufactured by The Lubrizol Corporation.

In order to more effectively and reliably obtain the operational effect of this embodiment, a content of the dispersant with respect to the total mass of the ink composition is preferably 3.0 to 8.0 percent by mass.

### 2.4. Surfactant

The ink composition may include a surfactant.

As the surfactant, for example, an acetylene glycol-based surfactant, a fluorine-based surfactant, or a silicone-based surfactant may be mentioned. The surfactant may be used alone, or at least two types thereof may be used in combination.

As the acetylene glycol-based surfactant, for example, there may be mentioned 2,4,7,9-tetramethyl-5-decyne-4,7-diol, an alkylene oxide adduct thereof, 2,4-dimethyl-5-decyne-4-ol, or an alkylene oxide adduct thereof.

As the acetylene glycol-based surfactant, a commercially available product may also be used. As the commercially available product, for example, there may be mentioned Olfine (registered trademark) 104 Series (trade name) or E Series (trade name) manufactured by Nisshin Chemical Industry Co., Ltd., or Surfynol (registered trademark) Series (trade name) manufactured by Air Products & Chemicals Inc.

As the fluorine-based surfactant, for example, there may be mentioned a perfluoroalkyl sulfonic acid salt, a perfluoroalkyl carboxylic acid salt, a perfluoroalkyl phosphate ester, a perfluoroalkyl ethylene oxide adduct, a perfluoroalkyl betaine, or a perfluoroalkyl amine oxide compound.

As the fluorine-based surfactant, a commercially available product may also be used. As the commercially available product, for example, S-144 (trade name) or S-145 (trade name) manufactured by Asahi Glass Co., Ltd. may be mentioned.

As the silicone-based surfactant, for example, a polysiloxane-based compound or a polyether modified organosiloxane may be mentioned.

As the silicon-based surfactant, a commercially available product may also be used. As the commercially available product, for example, there may be mentioned 306, 307, 333, 341, 345, 346, 347, 348, or 349 (trade name) of BYK (registered trademark) Series manufactured by BYK Japan KK.

In order to more effectively and reliably obtain the operational effect of this embodiment, a content of the surfactant with respect to the total mass of the ink composition is preferably 0.5 to 5.0 percent by mass.

### 2.5. Water-Soluble Organic Solvent

The ink composition may include a water-soluble organic solvent.

As the water-soluble organic solvent, for example, there may be mentioned glycerin; a glycol, such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, or 1,6-hexanediol; a glycol monoether, such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, or triethylene glycol monomethyl ether; a nitrogen-containing solvent, such as 2-pyrrolidone, N-methyl-2-pyrrolidone, or N-ethyl-2-pyrrolidone; or an alcohol, such as methanol, ethanol, n-propyl alcohol, iso-propyl alcohol, n-butanol, 2-butanol, tert-butanol, iso-butanol, n-pentanol, 2-pentanol, 3-pentanol, or tert-pentanol.

The water-soluble organic solvent may be used alone, or at least two types thereof may be used in combination.

In order to more effectively and reliably obtain the operational effect of this embodiment, a content of the water-soluble organic solvent with respect to the total mass of the ink composition is preferably 5 to 30 percent by mass.

### 2.6. Other Components

The ink composition may include various types of additives, such as a solubilizing agent, a viscosity adjuster, a pH adjuster, an antioxidant, an antiseptic agent, a fungicide, a corrosion inhibitor, and/or a chelating agent to trap metal ions influencing the dispersion.

The additives may be used alone, or at least two types thereof may be used in combination.

As the antiseptic agent, for example, sodium pentachlorophenol, 2-pyridinethiol-1-oxide sodium, or 1,2-dibenzine thiazoline-3-one may be mentioned.

As the antiseptic agent, a commercially available product may also be used. As the commercially available product, for example, there may be mentioned CRL, BND, GXL, XL-2, or TN (trade name) of Proxel (registered trademark) Series manufactured by Lonza Japan Ltd. The antiseptic agent may be used alone, or at least two types thereof may be used in combination.

A content of each additive with respect to the total mass of the ink composition is approximately 0.01 to 5.0 percent by mass.

### 2.7. Method for Manufacturing Ink Composition

The ink composition can be prepared such that after the dispersive dye and water are mixed together with, if needed, other components in an arbitrary order, impurities and foreign materials are removed, if needed, by filtration or the like. As a mixing method of the components, there may be used a method in which after the components are sequentially charged in a container equipped with a stirring device, such as a mechanical stirrer or a magnetic stirrer, stirring and mixing are performed. As a filtration method, a centrifugal filtration or a filter filtration may be mentioned.

In addition, in order to more preferably disperse the dispersive dye in the ink composition, a dye dispersant is prepared in advance, and the ink composition may be prepared using the dye dispersion instead of using the dispersive dye. The dye dispersion may be obtained such that after the dispersive dye, water, and the dispersion are mixed together in an arbitrary order, the mixture thus obtained is dispersed by a paint shaker or the like.

### 3. Composition Set

A composition set includes the treatment liquid composition described above and the ink composition described above.

In this embodiment, the treatment liquid composition is adhered in advance to a cloth containing fibers which have hydroxy groups, so that the cloth to which the treatment liquid composition is adhered is obtained. In addition, on the cloth to which the treatment liquid composition is adhered, printing is performed with the ink composition, so that a printed matter having sufficient color development property, discoloration resistance of a dyed portion with time, and fastness, such as abrasion resistance, can be easily obtained.

### 4. Cloth

A cloth according to this embodiment contains fibers which have hydroxy groups.

As the fibers which have hydroxy groups, for example, there may be mentioned natural fibers, such as cotton, hemp, wool, or silk; synthetic fibers, such as a polypropylene, a polyester, an acetate, a triacetate, a polyamide, or a polyurethane, which have hydroxy groups in its structure; or biodegradable fibers, such as polylactic acid. In addition, as the fibers which have hydroxy groups, blended fibers formed from those mentioned above may also be used.

Since a printed matter which has, besides more sufficient color development property, discoloration resistance, and fastness, a preferable texture and which is further less likely to be yellowed can be easily obtained, the cloth is preferably formed from cotton.

As the form of the cloth, for example, a woven cloth, a knitted cloth, a non-woven cloth, a fabric, a garment, and an accessory other than those mentioned above may be mentioned. As the garment and the accessory, for example, there may be mentioned sewn products, such as a T shirt, a handkerchief, a scarf, a towel, a handbag, and a cloth-made bag; furniture, such as a curtain, a sheet, a bed cover, and wallpaper; and fabrics before and after cutting to be used as materials to be sewn. As the forms of those materials mentioned above, for example, there may be mentioned a material having a long length in a roll shape, a material cut to have a predetermined size, and a material having a product shape. In addition, the cloth may be used as long as the treatment liquid composition is adhered thereto, and as the cloth, a cloth to which the treatment liquid composition is adhered in advance may also be used.

A weight per unit area of the cloth is preferably 1.0 to 10.0 Oz. When the weight per unit area of the cloth is in the range described above, preferable recording can be performed.

As long as containing fibers which have hydroxy groups, a cloth colored in advance with a dye may also be used as the cloth. Since the treatment liquid composition can suppress generation of treatment traces while the color development property, the discoloration resistance, and the fastness of the cloth are secured, even the cloth colored in advance may also be used as long as containing fibers which have hydroxy groups. That is, even if the cloth is colored in advance, the printing can be performed so that the color development property is excellent, the discoloration resistance and the fastness are maintained, and the generation of treatment traces is suppressed, and hence, the quality and the commercial value of the printed matter as the product can be increased as compared to that in the past.

As the dye to color the cloth in advance, for example, there may be mentioned a water-soluble dye, such as an acidic dye or a basic dye; a dispersive dye to be used in combination with a dispersant; a reactive dye; or a solvent dye. When a cotton cloth is used as the cloth, a dispersive dye or a reactive dye suitable for cotton dyeing is preferably used, and a dispersive dye is more preferable.

### 5. Printing Method

A printing method of this embodiment includes a treatment liquid composition adhesion step of adhering the treatment liquid composition to the cloth containing fibers which have hydroxy groups. By the step described above, the cloth to which the treatment liquid composition is adhered can be obtained. In addition, when the ink composition is adhered to the cloth described above, a printed matter having sufficient color development property, discoloration resistance, and fastness can be obtained.

After the above treatment liquid composition adhesion step is performed, the printing method preferably includes an ink composition adhesion step of adhering an ink composition to the cloth to which the treatment liquid composition is adhered. In addition, the ink composition to be adhered to the cloth is not particularly limited as long as containing a dispersive dye, and for example, the ink jet ink composition according to this embodiment may be used. In addition, as for the ink composition adhesion step, a printing method using an ink jet method which will be described later may be mentioned for reference.

In the printing method, various types of cloths may be used, and a preferable printing can be performed.

An adhesion amount of the treatment liquid composition to the cloth is preferably set, for example, to 0.02 to 0.5 g/cm² and more preferably set to 0.02 to 0.3 g/cm². Since the adhesion amount of the treatment liquid composition is set in the range described above, the treatment liquid composition can be more uniformly adhered to the cloth, aggregation irregularities of an image of the printed matter can be further suppressed, and the color development property can be improved.

As a method to adhere the treatment liquid composition to the cloth, for example, there may be mentioned an immersion coating method in which the cloth is immersed in the treatment liquid composition; a roller coating method in which the treatment liquid composition is coated by a mangle roller machine or a roll coater; a spray coating method in which the treatment liquid composition is sprayed by a spray device or the like; or an ink jet coating method in which the treatment liquid composition is sprayed by an ink jet method. In order to adhere the treatment liquid composition to the cloth, one of the coating methods described above may be used alone, or at least two methods thereof may be used in combination.

In this embodiment, since the degree of design freedom of the adhesion amount of the treatment liquid composition is increased, defects are not likely to be generated in the adhesion, and the treatment liquid composition can be uniformly adhered to the cloth, the treatment liquid composition is preferably adhered to the cloth using a roller machine, such as a mangle roller machine or a roll coater.

After the treatment liquid composition is adhered to the cloth, the printing method may further include a drying step of drying the treatment liquid composition adhered to the cloth. For the drying of the treatment liquid composition, although spontaneous drying may be performed, in order to increase the adhesion amount of the treatment liquid composition to the cloth and to improve a drying rate, the drying is preferably performed with heating.

As a heating method, for example, a heat press method, a normal pressure steam method, a high pressure steam method, or a thermofix method may be mentioned. In addition, as a heat source of the heating, for example, infrared rays (lamp) may be mentioned.

In addition, a heating temperature is preferably set, for example, to 180° C. or less. Accordingly, even when the cloth is colored in advance with a dye, while sublimation of the dye by heat drying is suppressed, discoloration of the color of the cloth can be suppressed. In addition, a lower limit of the heating temperature may be set so that a medium, such as water, contained in the treatment liquid composition is vaporized and is preferably set to 100° C. or more.

After the treatment liquid composition is adhered to the cloth, the printing method may include, if needed, a washing step. Since the printing method includes the step described above, components contained in the treatment liquid composition not adhered to the cloth can be removed.

### 6. Ink Jet Printing Method

An ink jet printing method is a method to adhere the ink composition to the cloth to which the treatment liquid composition is adhered by an ink jet method. By using the ink jet method, a dyed section having a fine pattern can be easily and reliably formed. In addition, this method can be applied to various types of cloths, and a preferable printing can be performed. By the ink jet printing method, even on a cloth having a certain thickness, a preferable printing having a small color difference between a front and a rear side can be performed. As the ink jet printing method, for example, an indirect printing recording method or a direct printing recording method may be mentioned.

### 6.1. Ink Jet Recording Apparatus

An ink jet recording apparatus used for the printing method is not particularly limited, and any apparatus may be used which at least includes an ink container to receive the ink composition and a recording head connected thereto and which ejects the ink composition from the recording head and forms an image on the cloth to which the treatment liquid composition is adhered or on transfer paper functioning as an intermediate transfer medium. In addition, as the ink jet recording apparatus, either a serial type or a line type may be used. In both the types of ink jet recording apparatuses, a recording head is mounted, and while a relative positional relationship between the recording head and the cloth or the transfer paper is changed, a predetermined volume of liquid droplets of the ink composition is intermittently ejected at a predetermined timing from nozzle holes of the recording head. Accordingly, the ink composition is adhered to the cloth or the transfer paper, so that a predetermined transfer image can be formed.

In general, in a serial type ink jet recording apparatus, a transport direction of a recording medium and a direction of reciprocal movement of the recording head are intersected to each other, and by the combination of the reciprocal movement of the recording head and the transport movement of the recording medium, the relative positional relationship between the recording medium and the recording head is changed. In addition, in the case described above, in general, a plurality of nozzle holes is disposed in the recording head, and along the transport direction of the recording medium, at least one line of the nozzle holes, that is, at least one nozzle line, is formed. In addition, in accordance with the types and the number of the ink compositions, a plurality of nozzle lines may be formed in the recording head in some cases.

In addition, in general, in a line type ink jet recording apparatus, the recording head performs no reciprocal movement, and the relative positional relationship between a recording medium and the recording head is changed by the transport of the recording medium. In the case described above, in general, a plurality of nozzle holes is also disposed in the recording head, and at least one nozzle line is formed along a direction intersecting the transport direction of the recording medium.

### 6.2. Indirect Printing Recording Method

An ink jet printing method of this embodiment includes a treatment liquid composition adhesion step of adhering the treatment liquid composition to the cloth containing fibers which have hydroxy groups, an ejection step of ejecting the ink composition from a recording head so as to be adhered to an intermediate transfer medium; and a transfer step of transferring the ink composition adhered to the intermediate transfer medium to the cloth to which the treatment liquid composition is adhered, the cloth being obtained in the treatment liquid composition adhesion step. In particular, by this printing method, the ink composition containing a dispersive dye, such as a sublimation dye, is ejected by a liquid ejecting head functioning as the recording head so as to be adhered to the intermediate transfer medium, and heating is then performed while a surface of the intermediate transfer medium to which the ink composition is adhered faces a cloth surface to which the treatment liquid composition is adhered so that the dispersive dye contained in the ink composition is transferred to the cloth to which the treatment liquid composition is adhered. In this embodiment, the printing method as described above is also called an indirect printing method. According to this printing method, a preferable printing can be performed without any restriction of the cloth form.

### 6.2.1. Treatment Liquid Composition Adhesion Step

As the treatment liquid composition adhesion step, the printing method described above may be mentioned for reference.

### 6.2.2. Ejection Step

In the ejection step, a heated ink composition is ejected from the liquid ejecting head so as to be adhered to the intermediate transfer medium. In particular, a pressure generating device is driven, and the ink composition filled in a pressure generating chamber of the liquid ejecting head is ejected from the nozzle.

As the intermediate transfer medium, for example, paper, such as regular paper, or a recording medium including an ink receiving layer may be used. As the recording medium including an ink receiving layer described above, for example, ink jet exclusive paper or coated paper may be mentioned. Among those mentioned above, paper including an ink receiving layer which contains inorganic particles, such as silica, is more preferable. Accordingly, in a process in which the ink composition applied to the intermediate transfer medium is dried, an intermediate recorded matter in which, for example, bleeding on a recording surface is suppressed can be obtained. In addition, according to the medium as described above, the dispersive dye is more likely to stay on the recording surface, and in the following transfer step, the sublimation of the dispersive dye can be more efficiently performed.

In this step, at least two types of ink compositions may be used. Accordingly, for example, a color gamut to be exhibited can be further increased. One of the at least two types of ink compositions described above may be the ink composition of this embodiment, and at least two types thereof each may be the ink composition of this embodiment.

### 6.2.3. Transfer Step

The transfer step is a step in which heating is performed such that while the surface of the intermediate transfer medium to which the ink composition is adhered faces the cloth surface to which the treatment liquid composition is adhered, the dispersive dye contained in the ink composition is transferred to the cloth to which the treatment liquid composition is adhered. Accordingly, the dispersive dye is transferred, and a printed matter which is the cloth to which the ink composition is adhered is obtained.

In this step, the heating may be performed while the intermediate transfer medium to which the ink composition is adhered faces the cloth to which the treatment liquid composition is adhered. In this step, the heating is more preferably performed while the intermediate transfer medium is in close contact with the cloth to which the treatment liquid composition is adhered. Accordingly, for example, a clearer image is recorded on the cloth to which the treatment liquid composition is adhered, that is, dyeing can be performed.

As a heating method, for example, a steaming method using vapor, a heat press method by dry heating, a thermosol method, an HT steamer method by a superheated vapor, or an HP steamer method by a pressurized vapor may be mentioned. On the cloth to which the ink composition is applied, a heating treatment may be performed immediately or after a predetermined time passes. Since a printed matter having sufficient color development property, discoloration resistance, and fastness can be obtained, as the heating method, dry heating is preferable.

A heating temperature is preferably 160° C. to 220° C. and more preferably 190° C. to 210° C. Since the heating temperature is in the range described above, energy required for the transfer can be further reduced, and the productivity of the printed matter tends to be further improved. In addition, the color development property of the printed matter tends to be further improved.

Although depending on the heating temperature, a heating time is preferably 30 to 120 seconds and more preferably 40 to 90 seconds. Since the heating time is in the range described above, the energy required for the transfer can be further reduced, and the productivity of the printed matter tends to be further improved. In addition, the color development property of the printed matter tends to be further improved.

An adhesion amount of the ink composition per unit area of the cloth to be adhered to the cloth by the transfer is preferably 1.5 to 6.0 mg/cm². Since the adhesion amount of the ink composition is in the range described above, the color development property of an image or the like to be formed by the printing is improved, and in addition, since the drying property of the ink adhered to the cloth is secured, bleeding of the image or the like can be suppressed from being generated.

### 6.2.4. Other Steps

This method may also include, if needed, an intermediate treatment step and a post-treatment step.

As the intermediate treatment step, for example, a step of preliminarily heating the cloth to which the treatment liquid composition is adhered may be mentioned.

As the post-treatment step, for example, a step of washing the printed matter may be mentioned.

### 6.3. Direct Printing Recording Method

An ink jet printing method of this embodiment may include a treatment liquid composition adhesion step of adhering the treatment liquid composition to the cloth containing fibers which have hydroxy groups and an ink composition adhesion step of ejecting the ink composition from a recording head so as to be adhered to the cloth to which the treatment liquid composition is adhered, the cloth being obtained in the treatment liquid composition adhesion step. In this embodiment, the printing method as described above is also called a direct printing method. According to this printing method, a dyed section having a fine pattern can be easily and reliably formed. In addition, since a printing plate, such as the intermediate transfer medium, is not required to be used, on-demand characteristics are excellent, and small quantity production and multi-product production can be preferably performed.

6.3.1. Step of Obtaining Cloth to which Treatment Liquid Composition is Adhered

As the treatment liquid composition adhesion step, the printing method described above may be mentioned for reference.

### 6.3.2. Ink Composition Adhesion Step

In the ink composition adhesion step, the ink composition is adhered to the cloth to which the treatment liquid composition is adhered. In addition, in the ink composition adhesion step, a step of further adhering the ink composition on a region to which the ink composition is adhered may be further included.

In the ink composition adhesion step, a maximum adhesion amount to the cloth is preferably 50 to 200 mg/cm² and more preferably 80 to 150 mg/cm². When the maximum adhesion amount is in the range described above, the color development property is further improved. In addition, rubbing fastness of an image is also improved, and aggregation irregularities tend to be less noticeable.

In this step, when the ink composition is adhered to the cloth to which the treatment liquid composition is adhered, heating is preferably performed. Accordingly, for example, on the cloth to which the treatment liquid composition is adhered, a clearer image can be recorded, that is, dyeing can be performed.

As a heating method, for example, a heat press method, a normal pressure steam method, a high pressure steam method, or a thermofix method may be mentioned. In addition, as a heat source of the heating, for example, a hot wind, infrared rays, or microwaves may be mentioned.

In the heating, a surface temperature of the cloth thus heated is preferably 60° C. to 180° C. Since the surface temperature thereof is in the range described above, damage on the ink jet head and/or the cloth can be reduced, and in addition, the ink is likely to uniformly wet spread on and permeate in the cloth. In addition, the surface temperature may be measured using, for example, a non-contact thermometer (trade name: IT2-80, manufactured by Keyence Corporation).

A heating time is preferably set, for example, to five seconds to five minutes. Since the heating time is set in the range described above, while the damage on the ink jet head and/or the cloth is reduced, the cloth can be sufficiently heated.

### 6.3.3. Other Steps

The method described above may further include, if needed, an intermediate treatment step and a post-treatment step. For the steps described above, the other steps of the indirect printing recording method described above may be mentioned for reference.

### EXAMPLES

Hereinafter, the present disclosure will be described in more detail with reference to Examples and Comparative Examples. However, the present disclosure is not limited at all to the following Examples.

### 1. Preparation of Dye Printing Treatment Liquid Composition

### Examples 1 to 15 and Comparative Examples 1 to 14

After components were charged in a mixing tank so as to have one of the compositions shown in Tables 1 and 2 and then mixed together by stirring, filtration was further performed using a 5-μm membrane filter, so that respective treatment liquid compositions were obtained.

In addition, the numerical value of the amount of each of the components shown in Tables 1 and 2 represents percent by mass. The “solid content” of each of the resin and the cross-linking agent represents percent by mass. The “Tg” of the resin represents a glass transition temperature (° C.). The “resin solid content” represents a solid content (parts by mass) of the resin in the treatment liquid composition. The “cross-linking agent solid content” represents a solid content (parts by mass) of the cross-linking agent in the treatment liquid composition, and the “cross-linking agent solid content/resin solid content” represents a mass ratio between the cross-linking agent and the polyester resin on a solid content basis.

In addition, the components shown in Tables 1 and 2 are as shown below.

### [Resin]

### (Styrene-Acrylic-Based Resin)

6960: Movinyl (registered trademark) 6960 (trade name, manufactured by Japan Coating Resin Corporation)

### (Sulfonic Acid Group-Containing Polyester Resin)

Z-3310: Plascoat (registered trademark) Z-3310 (trade name, manufactured by Goo Chemical Co., Ltd.)
Z-880: Plascoat (registered trademark) Z-880 (trade name, manufactured by Goo Chemical Co., Ltd.)
Z-592: Plascoat (registered trademark) Z-592 (trade name, manufactured by Goo Chemical Co., Ltd.)
Z-687: Plascoat (registered trademark) Z-687 (trade name, manufactured by Goo Chemical Co., Ltd.)
RZ-570: Plascoat (registered trademark) RZ-570 (trade name, manufactured by Goo Chemical Co., Ltd.)

### (Carboxy Group-Containing Polyester Resin)

RZ-760: Plascoat (registered trademark) RZ-760 (trade name, manufactured by Goo Chemical Co., Ltd.)

### (Polyester Resin)

MD-1480: Vylonal (registered trademark) MD-1480 (trade name, manufactured by Toyobo Co., Ltd.)
MD-2000: Vylonal (registered trademark) MD-2000 (trade name, manufactured by Toyobo Co., Ltd.)

### [Cross-Linking Agent]

#220: Fixer #220 (trade name, manufactured by Murayama

Chemical Laboratory Co., Ltd.)
K-2035E: Epocros (registered trademark) K-2035E (trade name, manufactured by Nippon Shokubai Co., Ltd.)

TABLE 1

| | | | SOLID | | | | | | | | | |
|---|---|---|---|---|---|---|---|---|---|---|---|---|
| | | | CONTENT | | | | | | | | | |
| | | | (PERCENT | Tg | EXAM- | EXAM- | EXAM- | EXAM- | EXAM- | EXAM- | EXAM- | EXAM- |
| | | | BY MASS) | (° C.) | PLE 1 | PLE 2 | PLE 3 | PLE 4 | PLE 5 | PLE 6 | PLE 7 | PLE 8 |
| TREATMENT | RESIN | 6960 | 45 | −23 | | | | | | | | |
| LIQUID | | Z-3310 | 25 | −20 | | | | | | | | |
| COMPOSITION | | MD-1480 | 25 | 20 | | | | | | | | |
| (PERCENT BY | | Z-880 | 25 | 20 | | | | | | | | |
| MASS) | | Z-592 | 25 | 40 | 4 | 8 | | | | | | |
| | | RZ-760 | 25 | 52 | | | 4 | 8 | 8 | | | |
| | | RZ-570 | 25 | 60 | | | | | | 4 | 8 | |
| | | MD-2000 | 40 | 67 | | | | | | | | 2.5 |
| | | Z-687 | 25 | 110 | | | | | | | | |
| | CROSS- | #220 | 40 | — | 1.25 | 2.5 | 1.25 | 2.5 | | 1.25 | 2.5 | 0.3 |
| | LINKING | K-2035E | 40 | | | | | | 5 | | | |
| | AGENT | | | | | | | | | | | |
| | | WATER | — | — | BAL- | BAL- | BAL- | BAL- | BAL- | BAL- | BAL- | BAL- |
| | | | | | ANCE | ANCE | ANCE | ANCE | ANCE | ANCE | ANCE | ANCE |

| | | | | | | | | |
|---|---|---|---|---|---|---|---|---|
| TOTAL | 100 | 100 | 100 | 100 | 100 | 100 | 100 | 100 |
| RESIN SOLID CONTENT | 1 | 2 | 1 | 2 | 2 | 1 | 2 | 1 |
| (PARTS BY MASS) | | | | | | | | |
| CROSS-LINKING AGENT SOLID | 0.50 | 0.50 | 0.50 | 0.50 | 1.00 | 0.50 | 0.50 | 0.12 |
| CONTENT/RESIN SOLID CONTENT | | | | | | | | |

| | | | SOLID | | | | | | | | |
|---|---|---|---|---|---|---|---|---|---|---|---|
| | | | CONTENT | | | | | | | | |
| | | | (PERCENT | Tg | EXAM- | EXAM- | EXAM- | EXAM- | EXAM- | EXAM- | EXAM- |
| | | | BY MASS) | (° C.) | PLE 9 | PLE 10 | PLE 11 | PLE 12 | PLE 13 | PLE 14 | PLE 15 |
| TREATMENT | RESIN | 6960 | 45 | −23 | | | | | | | |
| LIQUID | | Z-3310 | 25 | −20 | | | | | | | |
| COMPOSITION | | MD-1480 | 25 | 20 | | | | | | | |
| (PERCENT BY | | Z-880 | 25 | 20 | | | | | | | |
| MASS) | | Z-592 | 25 | 40 | | | | | | | |
| | | RZ-760 | 25 | 52 | | | | | | | 20 |
| | | RZ-570 | 25 | 60 | | | | | | | |
| | | MD-2000 | 40 | 67 | 5 | 7.5 | 12.5 | 17.5 | | | |
| | | Z-687 | 25 | 110 | | | | | 4 | 8 | |
| | CROSS- | #220 | 40 | — | 0.6 | 0.9 | 0.6 | 0.6 | 1.25 | 2.5 | 2.5 |
| | LINKING | K-2035E | 40 | | | | | | | | |
| | AGENT | | | | | | | | | | |
| | | WATER | — | — | BAL- | BAL- | BAL- | BAL- | BAL- | BAL- | BAL- |
| | | | | | ANCE | ANCE | ANCE | ANCE | ANCE | ANCE | ANCE |

| | | | | | | | |
|---|---|---|---|---|---|---|---|
| TOTAL | 100 | 100 | 100 | 100 | 100 | 100 | 100 |
| RESIN SOLID CONTENT | 2 | 3 | 5 | 7 | 1 | 2 | 5 |
| (PARTS BY MASS) | | | | | | | |
| CROSS-LINKING AGENT SOLID | 0.12 | 0.12 | 0.05 | 0.03 | 0.50 | 0.50 | 0.20 |
| CONTENT/RESIN SOLID CONTENT | | | | | | | |

TABLE 2

| | | | SOLID | | COMPAR- | COMPAR- | COMPAR- | COMPAR- | COMPAR- |
|---|---|---|---|---|---|---|---|---|---|
| | | | CONTENT | | ATIVE | ATIVE | ATIVE | ATIVE | ATIVE |
| | | | (PERCENT | Tg | EXAM- | EXAM- | EXAM- | EXAM- | EXAM- |
| | | | BY MASS) | (° C.) | PLE 1 | PLE 2 | PLE 3 | PLE 4 | PLE 5 |
| TREATMENT | RESIN | 6960 | 45 | −23 | NO | NO | 2.2 | | |
| LIQUID | | Z-3310 | 25 | −20 | PREPARATION | PREPARATION | | 4 | 8 |
| COMPOSITION | | MD-1480 | 25 | 20 | OF TREATMENT | OF TREATMENT | | | |
| (PERCENT BY | | Z-880 | 25 | 20 | LIQUID | LIQUID | | | |
| MASS) | | Z-592 | 25 | 40 | COMPOSITION | COMPOSITION | | | |
| | | RZ-760 | 25 | 52 | | | | | |
| | | RZ-570 | 25 | 60 | | | | | |
| | | MD-2000 | 40 | 67 | | | | | |
| | | Z-687 | 25 | 110 | | | | | |
| | CROSS- | #220 | 40 | — | | | | | |
| | LINKING | K-2035E | 40 | | | | | | |
| | AGENT | | | | | | | | |
| | | WATER | — | — | | | BAL- | BAL- | BAL- |
| | | | | | | | ANCE | ANCE | ANCE |

| | | | | | |
|---|---|---|---|---|---|
| TOTAL | — | — | 100 | 100 | 100 |
| RESIN SOLID CONTENT | — | — | 1.0 | 1.0 | 2.0 |
| (PARTS BY MASS) | | | | | |
| CROSS-LINKING AGENT SOLID | — | — | — | — | — |
| CONTENT/RESIN SOLID CONTENT | | | | | |

| | | | SOLID | | COMPAR- | COMPAR- | COMPAR- | COMPAR- | COMPAR- |
|---|---|---|---|---|---|---|---|---|---|
| | | | CONTENT | | ATIVE | ATIVE | ATIVE | ATIVE | ATIVE |
| | | | (PERCENT | Tg | EXAM- | EXAM- | EXAM- | EXAM- | EXAM- |
| | | | BY MASS) | (° C.) | PLE 6 | PLE 7 | PLE 8 | PLE 9 | PLE 10 |
| TREATMENT | RESIN | 6960 | 45 | −23 | | | | | |
| LIQUID | | Z-3310 | 25 | −20 | 8 | | | | |
| COMPOSITION | | MD-1480 | 25 | 20 | | 4 | | | |
| (PERCENT BY | | Z-880 | 25 | 20 | | | 4 | 8 | |
| MASS) | | Z-592 | 25 | 40 | | | | | |
| | | RZ-760 | 25 | 52 | | | | | |
| | | RZ-570 | 25 | 60 | | | | | 4 |
| | | MD-2000 | 40 | 67 | | | | | |
| | | Z-687 | 25 | 110 | | | | | |
| | CROSS- | #220 | 40 | — | 2.5 | | | | |
| | LINKING | K-2035E | 40 | | | | | | |
| | AGENT | | | | | | | | |
| | | WATER | — | — | BAL- | BAL- | BAL- | BAL- | BAL- |
| | | | | | ANCE | ANCE | ANCE | ANCE | ANCE |

| | | | | | |
|---|---|---|---|---|---|
| TOTAL | 100 | 100 | 100 | 100 | 100 |
| RESIN SOLID CONTENT | 2.0 | 1.0 | 1.0 | 2.0 | 1.0 |
| (PARTS BY MASS) | | | | | |
| CROSS-LINKING AGENT SOLID | 0.3 | — | — | — | — |
| CONTENT/RESIN SOLID CONTENT | | | | | |

| | | | SOLID | | COMPAR- | COMPAR- | COMPAR- | COMPAR- |
|---|---|---|---|---|---|---|---|---|
| | | | CONTENT | | ATIVE | ATIVE | ATIVE | ATIVE |
| | | | (PERCENT | Tg | EXAM- | EXAM- | EXAM- | EXAM- |
| | | | BY MASS) | (° C.) | PLE 11 | PLE 12 | PLE 13 | PLE 14 |
| TREATMENT | RESIN | 6960 | 45 | −23 | | | | |
| LIQUID | | Z-3310 | 25 | −20 | | | | |
| COMPOSITION | | MD-1480 | 25 | 20 | | | | |
| (PERCENT BY | | Z-880 | 25 | 20 | | | | |
| MASS) | | Z-592 | 25 | 40 | | | | |
| | | RZ-760 | 25 | 52 | | | 28 | |
| | | RZ-570 | 25 | 60 | | | | |
| | | MD-2000 | 40 | 67 | 2.5 | | | 17.5 |
| | | Z-687 | 25 | 110 | | 4 | | |
| | CROSS- | #220 | 40 | — | | | | |
| | LINKING | K-2035E | 40 | | | | | |
| | AGENT | | | | | | | |
| | | WATER | — | — | BAL- | BAL- | BAL- | BAL- |
| | | | | | ANCE | ANCE | ANCE | ANCE |

| | | | | |
|---|---|---|---|---|
| TOTAL | 100 | 100 | 100 | 100 |
| RESIN SOLID CONTENT | 1.0 | 1.0 | 7.0 | 7.0 |
| (PARTS BY MASS) | | | | |
| CROSS-LINKING AGENT SOLID | — | — | — | — |
| CONTENT/RESIN SOLID CONTENT | | | | |

In addition, in Comparative Examples 1 and 2, the treatment liquid composition was not prepared.

### 2. Preparation of Ink Jet Ink Composition

### Dye Dispersants 1 to 3

Components were charged in a mixing tank to have one of the compositions shown in Table 3 and then dispersed by a paint shaker using 0.3-mm zirconia beads, so that dye dispersants 1 to 3 were obtained. In addition, the numerical value of each component in Table 3 represents percent by mass.

In addition, the components shown in Table 3 are as shown below.

### [Dispersive Dye]

Disperse Blue 359: C.I. Disperse Blue 359 (commercially available product)
Disperse Red 60: C.I. Disperse Red 60 (commercially available product)
Disperse Yellow 54: C.I. Disperse Yellow 54 (commercially available product)

### [Dispersant]

Solsperse® 43000: Solsperse (registered trademark) 43000 (trade name, acryl-styrene-based resin, manufactured by The Lubrizol Corporation)

TABLE 3

| | | | DYE | DYE | DYE |
|---|---|---|---|---|---|
| | | | DISPERSANT | DISPERSANT | DISPERSANT |
| | | | 1 | 2 | 3 |
| DYE | DISPERSIVE | Disperse Blue | 15 | | |
| DISPERSANT | DYE | 359 | | | |
| (PERCENT BY | | Disperse Red | | 15 | |
| MASS) | | 60 | | | |
| | | Disperse | | | 15 |
| | | Yellow 54 | | | |
| | DISPERSANT | SOLSPERSE | 15 | 15 | 15 |
| | | (R) 43000 | | | |

| | | | |
|---|---|---|---|
| PURE WATER | 70 | 70 | 70 |
| TOTAL | 100 | 100 | 100 |

### C Ink, M Ink, and Y Ink

Components were charged in a mixing tank to have one of the compositions shown in Table 4 and then mixed and stirred by a stirrer for 2 hours. Subsequently, filtration was performed using a membrane filter having a pore size of 1 μm, so that a C ink, an M ink, and a Y ink were each obtained as the ink composition. In addition, the numerical value of each component in Table 4 represents percent by mass.

In addition, the components shown in Table 4 are as shown below.

### [Dye Dispersant]

The dye dispersants 1 to 3 obtained as described above were each used.

### [Surfactant]

BYK®-348: BYK (registered trademark)-348 (trade name, silicone-based surfactant, manufactured by BYK Japan KK)

### [Water-Soluble Organic Solvent]

glycerin
propylene glycol

### [Antiseptic Agent]

Proxel® XL-2: Proxel (registered trademark) XL-2 (trade name, manufactured by Lonza Japan Ltd.)

TABLE 4

| | | | C INK | M INK | Y INK |
|---|---|---|---|---|---|
| INK JET INK | DYE | DYE | 30 | | |
| COMPOSITION | DISPERSANT | DISPERSANT 1 | | | |
| (PERCENT BY MASS) | | DYE | | 43.3 | |
| | | DISPERSANT 2 | | | |
| | | DYE | | | 20 |
| | | DISPERSANT 3 | | | |
| | SURFACTANT | BYK(R)-348 | 0.8 | 0.8 | 0.8 |
| | WATER-SOLUBLE | GLYCERIN | 15 | 10 | 15 |
| | ORGANIC | PROPYLENE | 10 | 10 | 10 |
| | SOLVENT | GLYCOL | | | |
| | ANTISEPTIC | PROXEL(R)XL-2 | 0.2 | 0.2 | 0.2 |
| | AGENT | | | | |

| | | | |
|---|---|---|---|
| PURE WATER | 44 | 35.7 | 54 |
| TOTAL | 100 | 100 | 100 |

### 3. Formation of Printed Matter

### 3.1. Formation of Cloth to which Treatment Liquid Composition is Adhered

### Examples 1 to 15 and Comparative Examples 3 to 12

The treatment liquid composition of each of Examples 1 to 15 and Comparative Examples 3 to 12 was adhered to a cloth. In particular, the cloth to which the treatment liquid composition was adhered was obtained as described below.

A white cotton braid #4000 (trade name, manufactured by Toyobo Co., Ltd.) was immersed as the cloth in the treatment liquid composition, and the treatment liquid composition was applied to the cloth at a squeezing rate of 80% by a mangle roller machine. Subsequently, after the cloth thus treated was dried at 120° C. for 2 minutes, drying was further performed at 170° C. for 1 minute, so that the cloth to which the treatment liquid composition was adhered of each Examples and Comparative Examples was obtained.

In addition, the squeezing rate (S) was calculated by the following equation (1).

S (%)=[(A−B)/B]×100 (1)

In addition, in the above equation (1), S represents the squeezing rate (%), A represents a mass of the cloth to which the treatment liquid composition is adhered, and B represents a mass of the cloth before the treatment liquid composition is adhered thereto.

### Examples 16 to 20 and Comparative Examples 13 and 14

The treatment liquid composition of each of Examples 7, 15, 9, 11, and 12 and Comparative Examples 13 and 14 was adhered to a cloth. In particular, the cloth to which the treatment liquid composition was adhered was obtained as described below.

The treatment liquid composition was uniformly adhered by a spray to an A4-size breast area surface of a commercially available T shirt as the cloth. Subsequently, after the cloth thus treated was dried at 120° C. for 2 minutes, drying was further performed at 170° C. for 30 seconds, so that the cloth to which the treatment liquid composition was adhered of each Examples and Comparative Examples was obtained.

### 3.2. Formation of Intermediate Recording Medium to which Ink Composition is Adhered

### Examples 1 to 20 and Comparative Examples 1 to 14

The C ink, the M ink, and the Y ink were filled in respective cartridges of an ink jet printer PX-G930 (trade name, manufactured by Seiko Epson Corporation). Subsequently, on a coating layer of coated paper (TRANSJET Sportline 1254 (trade name), manufactured by Chem Paper) functioning as an intermediate transfer medium, the three types of inks were each adhered so as not to be overlapped with each other at a resolution of 720 dpi×720 dpi and an ink ejection amount of 12 mg/inch² at a duty of 100%, so that an image having three types of solid patterns was formed. Accordingly, an intermediate recording medium to which the ink compositions were adhered was obtained.

### 3.3. Printing

### Examples 1 to 15 and Comparative Examples 3 to 12

The surface of the intermediate recording medium to which the ink compositions described above were adhered and on which the image was formed was thermal transferred to the cloth (cotton braid) to which the treatment liquid composition described above was adhered at a temperature 200° C. and a pressure of 4.2 N/cm³ for 60 seconds using a heat press machine TP-608M (trade name, manufactured by Taiyo Seiki Co., Ltd.), so that a printed matter which was the cloth to which the C ink, the M ink, and the Y ink were adhered of each of Examples and Comparative Examples was obtained.

### Examples 16 to 20 and Comparative Examples 13 and 14

The surface of the intermediate recording medium to which the ink compositions described above were adhered and on which the image was formed was thermal transferred to the cloth (T shirt) to which the treatment liquid composition described above was adhered at a temperature 200° C. and a pressure of 4.2 N/cm³ for 60 seconds using a heat press machine TP-608M (trade name, manufactured by Taiyo Seiki Co., Ltd.), so that a printed matter which was the cloth to which the C ink, the M ink, and the Y ink were adhered of each of Examples and Comparative Examples was obtained.

### Comparative Example 1

The surface of the intermediate recording medium to which the ink compositions described above were adhered and on which the image was formed was thermal transferred to a white polyester cloth Curl Dry K-1 (trade name, manufactured by Toray Industries, Inc.) at a temperature 200° C. and a pressure of 4.2 N/cm³ for 60 seconds using a heat press machine TP-608M (trade name, manufactured by Taiyo Seiki Co., Ltd.), so that a printed matter which was the cloth to which the C ink, the M ink, and the Y ink were adhered was obtained.

### Comparative Example 2

The surface of the intermediate recording medium to which the ink composition described above was adhered and on which the image was formed was thermal transferred to a white cotton braid #4000 (trade name, manufactured by Nisshinbo Holdings Inc.) at a temperature 200° C. and a pressure of 4.2 N/cm³ for 60 seconds using a heat press machine TP-608M (trade name, manufactured by Taiyo Seiki Co., Ltd.), so that a printed matter which was the cloth to which the C ink, the M ink, and the Y ink were adhered was obtained.

### 4. Evaluation Method

### 4.1. Discoloration Resistance

A color density (OD value) of each printed matter to which the C ink, the M ink, and the Y ink were adhered was measured immediately after the printing at a room temperature of 25° C. under the following measurement conditions using a fluorescence spectrophotometer FD-7 (trade name, manufactured by Konica Minolta, Inc.). Subsequently, after the printed matter described above was left at a room temperature of 25° C. for three days, the color density (OD value) of the printed matter was measured under conditions similar to those described above.

Measurement Conditions
Observation light source: D65
Observation field: 2°
Status: T
UV filter: mounted

By comparison between the OD value of the printed matter immediately after the printing and the OD value of the printed matter left for three days, the discoloration resistance of the printed matter of each of Examples 1 to 15 and Comparative Examples 1 to 12 was evaluated in accordance with the following evaluation criteria. The results are shown in Tables 5 and 6.

Evaluation Criteria

A: Decrease rates of all OD vales of three colors are each less than 2%.
B: Decrease rate of OD value of one of three colors is 2% to less than 5%, and decrease rates of OD values of the other colors are each less than 2%.
C: Decrease rate of OD value of one of three colors is 5% or more, and decrease rates of OD values of the other colors are each less than 5%.

### 4.2. Color Development Property

### 4.2.1. Color Development Property of C Ink

The printed matter to which the C ink, the M ink, and the Y ink were adhered was left at a room temperature of 25° C. for three days. Subsequently, a color density (OD value) of the C ink of the printed matter thus left was measured at a room temperature of 25° C. under the following conditions using a fluorescence spectrophotometer FD-7 (trade name, manufactured by Konica Minolta, Inc.).

Measurement Conditions
Observation light source: D65
Observation field: 2°
Status: T
UV filter: mounted

Subsequently, the OD value of the printed matter of each of Examples 1 to 15 and Comparative Examples 1 and 3 to 12 was compared with the OD value of the printed matter of Comparative Example 2, and the color development property of the C ink was evaluated in accordance with the following evaluation criteria. The results are shown in Tables 5 and 6.

Evaluation Criteria

A: OD value is 200% or more as compared to OD value of printed matter of Comparative Example 2.
B: OD value is 180% to less than 200% as compared to OD value of printed matter of Comparative Example 2.
C: OD value is 170% to less than 180% as compared to OD value of printed matter of Comparative Example 2.
D: OD value is 160% to less than 170% as compared to OD value of printed matter of Comparative Example 2.
E: OD value is less than 160% as compared to OD value of printed matter of Comparative Example 2.

### 4.2.2. Color Development Property of M Ink

A color density (OD value) of the M ink of each printed matter left for three days was measured under conditions similar to those described above using a fluorescence spectrophotometer FD-7 (trade name, manufactured by Konica Minolta, Inc.).

Subsequently, the OD value of the printed matter of each of Examples 1 to 15 and Comparative Examples 1 and 3 to 12 was compared with the OD value of the printed matter of Comparative Example 2, and the color development property of the M ink was then evaluated in accordance with the following evaluation criteria. The results are shown in Tables 5 and 6.

Evaluation Criteria

A: OD value is 190% or more as compared to OD value of printed matter of Comparative Example 2.
B: OD value is 180% to less than 190% as compared to OD value of printed matter of Comparative Example 2.
C: OD value is 170% to less than 180% as compared to OD value of printed matter of Comparative Example 2.
D: OD value is 160% to less than 170% as compared to OD value of printed matter of Comparative Example 2.
E: OD value is less than 160% as compared to OD value of printed matter of Comparative Example 2.

### 4.2.3. Color Development Property of Y Ink

A color density (OD value) of the Y ink of each printed matter left for three days was measured under conditions similar to those described above using a fluorescence spectrophotometer FD-7 (trade name, manufactured by Konica Minolta, Inc.).

Subsequently, the OD value of the printed matter of each of Examples 1 to 15 and Comparative Examples 1 and 3 to 12 was compared with the OD value of the printed matter of Comparative Example 2, and the color development property of the Y ink was then evaluated in accordance with the following evaluation criteria. The results are shown in Tables 5 and 6.

Evaluation Criteria

A: OD value is 200% or more as compared to OD value of printed matter of Comparative Example 2.
B: OD value is 180% to less than 200% as compared to OD value of printed matter of Comparative Example 2.
C: OD value is 170% to less than 180% as compared to OD value of printed matter of Comparative Example 2.
D: OD value is 160% to less than 170% as compared to OD value of printed matter of Comparative Example 2.
E: OD value is less than 160% as compared to OD value of printed matter of Comparative Example 2.

### 4.3. Fastness

A printed matter in which the C ink, the M ink, and the Y ink were adhered was formed in accordance with the formation of the printed matter described above and was then left at a room temperature of 25° C. for one hour. Subsequently, a test was performed on a recorded surface of the printed matter in accordance with a humidity test of ISO-105 X12 using a Gakushin-type rubbing fastness tester AB-301 (trade name, manufactured by Tester Sangyo Co., Ltd.), and rubbing fastness was evaluated in accordance with the following evaluation criteria using a contamination gray scale. The evaluation result represents the degree of fastness in the order of AA, A, B, to C. When the evaluation result is B or higher, the fastness is regarded as excellent. The results are shown in Tables 5 and 6.

Evaluation Criteria

AA: Rubbing fastness of all three colors exceeds grade III.
A: Rubbing fastness of one of three colors is grade III, and rubbing fastness of other colors exceeds grade III.
B: Rubbing fastness of one of three colors is grade II to less than grade III, and rubbing fastness of other colors is grade III or more.
C: Rubbing fastness of one of three colors is less than grade II, and rubbing fastness of other colors is grade II or more.

### 4.4. Texture

After a printed matter in which the C ink, the M ink, and the Y ink were adhered was formed in accordance with the formation of the printed matter described above, texture of the printed matter thus obtained was evaluated by a sensory test. In particular, arbitrarily selected five judgers evaluated the printed matter thus obtained as “not inferior to intrinsic hand touch feeling of cloth” or “printed matter feels coarse and stiff, and intrinsic hand touch feeling of cloth is deteriorated”, and the texture was evaluated in accordance with the results thus obtained and the following evaluation criteria. When the evaluation result is B or higher, the texture is regarded as excellent.

A: Number of judgers who judged printed matter as “not inferior to intrinsic hand touch feeling of cloth” is four or more.
B: Number of judgers who judged printed matter as “not inferior to intrinsic hand touch feeling of cloth” is three.
C: Number of judgers who judged printed matter as “not inferior to intrinsic hand touch feeling of cloth” is one or two.

The results are shown in Table 7. In addition, description of the numerical value and the like in Table 7 is similar to those in Tables 1 and 2.

TABLE 5

| | | EXAM- | EXAM- | EXAM- | EXAM- | EXAM- | EXAM- | EXAM- | EXAM- |
|---|---|---|---|---|---|---|---|---|---|
| | | PLE 1 | PLE 2 | PLE 3 | PLE 4 | PLE 5 | PLE 6 | PLE 7 | PLE 8 |
| EVALUATION | CLOTH | COTTON | COTTON | COTTON | COTTON | COTTON | COTTON | COTTON | COTTON |
| RESULT | DISCOLORATION | B | B | B | B | B | B | A | B |
| | RESISTANCE | | | | | | | | |
| | COLOR | B | B | B | A | A | B | A | B |
| | DEVELOPMENT | | | | | | | | |
| | PROPERTY OF | | | | | | | | |
| | C INK | | | | | | | | |
| | COLOR | B | B | B | A | A | B | A | B |
| | DEVELOPMENT | | | | | | | | |
| | PROPERTY OF | | | | | | | | |
| | M INK | | | | | | | | |
| | COLOR | B | B | B | B | B | B | A | B |
| | DEVELOPMENT | | | | | | | | |
| | PROPERTY OF | | | | | | | | |
| | Y INK | | | | | | | | |
| | FASTNESS | B | A | A | AA | A | A | AA | A |

| | | EXAM- | EXAM- | EXAM- | EXAM- | EXAM- | EXAM- | EXAM- |
|---|---|---|---|---|---|---|---|---|
| | | PLE 9 | PLE 10 | PLE 11 | PLE 12 | PLE 13 | PLE 14 | PLE 15 |
| EVALUATION | CLOTH | COTTON | COTTON | COTTON | COTTON | COTTON | COTTON | COTTON |
| RESULT | DISCOLORATION | A | A | A | A | B | A | A |
| | RESISTANCE | | | | | | | |
| | COLOR | A | A | A | A | B | A | A |
| | DEVELOPMENT | | | | | | | |
| | PROPERTY OF | | | | | | | |
| | C INK | | | | | | | |
| | COLOR | A | A | A | A | B | B | A |
| | DEVELOPMENT | | | | | | | |
| | PROPERTY OF | | | | | | | |
| | M INK | | | | | | | |
| | COLOR | A | A | A | A | B | A | A |
| | DEVELOPMENT | | | | | | | |
| | PROPERTY OF | | | | | | | |
| | Y INK | | | | | | | |
| | FASTNESS | AA | AA | AA | AA | A | A | A |

TABLE 6

| | | COMPAR- | COMPAR- | COMPAR- | COMPAR- | COMPAR- | COMPAR- |
|---|---|---|---|---|---|---|---|
| | | ATIVE | ATIVE | ATIVE | ATIVE | ATIVE | ATIVE |
| | | EXAM- | EXAM- | EXAM- | EXAM- | EXAM- | EXAM- |
| | | PLE 1 | PLE 2 | PLE 3 | PLE 4 | PLE 5 | PLE 6 |
| EVALUATION | CLOTH | PES | COTTON | COTTON | COTTON | COTTON | COTTON |
| RESULT | DISCOLORATION | A | B | C | C | C | C |
| | RESISTANCE | | | | | | |
| | COLOR | A | E | E | E | A | A |
| | DEVELOPMENT | | | | | | |
| | PROPERTY OF | | | | | | |
| | C INK | | | | | | |
| | COLOR | A | E | E | E | A | A |
| | DEVELOPMENT | | | | | | |
| | PROPERTY OF | | | | | | |
| | M INK | | | | | | |
| | COLOR | A | E | E | E | C | C |
| | DEVELOPMENT | | | | | | |
| | PROPERTY OF | | | | | | |
| | Y INK | | | | | | |
| | FASTNESS | AA | A | B | B | B | A |
| | | COMPAR- | COMPAR- | COMPAR- | COMPAR- | COMPAR- | COMPAR- |
| | | ATIVE | ATIVE | ATIVE | ATIVE | ATIVE | ATIVE |
| | | EXAM- | EXAM- | EXAM- | EXAM- | EXAM- | EXAM- |
| | | PLE 7 | PLE 8 | PLE 9 | PLE 10 | PLE 11 | PLE 12 |
| EVALUATION | CLOTH | COTTON | COTTON | COTTON | COTTON | COTTON | COTTON |
| RESULT | DISCOLORATION | C | C | C | B | B | B |
| | RESISTANCE | | | | | | |
| | COLOR | E | B | A | C | D | B |
| | DEVELOPMENT | | | | | | |
| | PROPERTY OF | | | | | | |
| | C INK | | | | | | |
| | COLOR | B | B | A | B | C | B |
| | DEVELOPMENT | | | | | | |
| | PROPERTY OF | | | | | | |
| | M INK | | | | | | |
| | COLOR | E | D | B | D | E | C |
| | DEVELOPMENT | | | | | | |
| | PROPERTY OF | | | | | | |
| | Y INK | | | | | | |
| | FASTNESS | B | B | B | B | B | B |

TABLE 7

| | | | | | | | COMPAR- | COMPAR- |
|---|---|---|---|---|---|---|---|---|
| | | | | | | | ATIVE | ATIVE |
| | | EXAM- | EXAM- | EXAM- | EXAM- | EXAM- | EXAM- | EXAM- |
| | | PLE 16 | PLE 17 | PLE 18 | PLE 19 | PLE 20 | PLE 13 | PLE 14 |
| TREATMENT LIQUID COMPOSITION | | (EXAM- | (EXAM- | (EXAM- | (EXAM- | (EXAM- | (COMPAR- | (COMPAR- |
| | | PLE 7) | PLE 15) | PLE 9) | PLE 11) | PLE 12) | ATIVE | ATIVE |
| | | | | | | | EXAM- | EXAM- |
| | | | | | | | PLE 13) | PLE 14) |
| RESIN | RZ-760 (SOLID | 8 | 20 | | | | 28 | |
| | CONTENT: 25 PERCENT | | | | | | | |
| | BY MASS, Tg: 52° C.) | | | | | | | |
| | MD-2000 (SOLID | | | 5 | 12.5 | 17.5 | | 17.5 |
| | CONTENT: 40 PERCENT | | | | | | | |
| | BY MASS, Tg: 67° C.) | | | | | | | |
| CROSS-LINKING | #220 (SOLID CONTENT: | 2.5 | 2.5 | 0.6 | 0.6 | 0.6 | | |
| AGENT | 40 PERCENT BY MASS) | | | | | | | |
| | WATER | BAL- | BAL- | BAL- | BAL- | BAL- | BAL- | BAL- |
| | | ANCE | ANCE | ANCE | ANCE | ANCE | ANCE | ANCE |
| TOTAL | | 100 | 100 | 100 | 100 | 100 | 100 | 100 |
| RESIN SOLID CONTENT | | 2 | 5 | 2 | 5 | 7 | 7 | 7 |
| (PARTS BY MASS) | | | | | | | | |
| CROSS-LINKING AGENT SOLID | | 0.50 | 0.20 | 0.12 | 0.05 | 0.03 | — | — |
| CONTENT/RESIN SOLID CONTENT | | | | | | | | |
| EVALUATION | CLOTH | COTTON | COTTON | COTTON | COTTON | COTTON | COTTON | COTTON |
| RESULT | TEXTURE | A | B | A | B | C | C | C |

As shown in Tables 5 and 6, it was found that when the treatment liquid composition of this embodiment is adhered to the cotton cloth containing fibers which have hydroxy groups, and the cotton cloth to which the treatment liquid composition is adhered is printed, a printed matter having sufficient color development property, discoloration resistance of a dyed portion with time, and fastness, such as abrasion resistance, can be easily obtained.

In addition, as shown in Table 5, it was found that when the mass ratio of the polyester resin to the cross-linking agent (polyester resin:cross-linking agent) is in a range of 1:0.01 to 1:1.2, a printed matter having more sufficient color development property, discoloration resistance, and fastness can be obtained.

From comparison of Examples 1, 3, 6, and 8 with Examples 2, 4, 5, 7, and 9 to 12, it was found that when the content of the polyester resin with respect to the total mass of the treatment liquid composition is in a range of 1.5 to 8.0 percent by mass on a solid content basis, a printed matter having a more excellent fastness together with more sufficient color development property and discoloration resistance can be obtained.

From comparison of Examples 7, 9, 11, and 15 to 19 with Examples 12 and 20 and Comparative Examples 13 and 14, it was found that when the content of the polyester resin with respect to the total mass of the treatment liquid composition is in a range of 1.0 to 6.0 percent by mass on a solid content basis, a printed matter having a preferable texture together with more sufficient color development property, discoloration resistance, and fastness can be obtained.

In addition, from comparison of Examples 7, 9, 11, and 15 to 19 with Examples 12 and 20, it was found that when the mass ratio of the polyester resin to the cross-linking agent (polyester resin:cross-linking agent) is in a range of 1:0.05 to 1:0.70, a printed matter having a preferable texture together with more sufficient color development property, discoloration resistance, and fastness can be obtained.

From comparison of Examples 7, 9, 16, and 18 with Examples 11, 12, 15, 17, 19, and 20 and Comparative Examples 13 and 14, it was found that when the content of the polyester resin with respect to the total mass of the treatment liquid composition is in a range of 1.5 to 4.0 percent by mass on a solid content basis, a printed matter having a more preferable texture together with sufficient color development property, discoloration resistance, and fastness can be obtained.

What is claimed is:

1. A dye printing treatment liquid composition to be adhered to a cloth, the treatment liquid composition comprising:
a polyester resin having a glass transition temperature of 40° C. or more;
a cross-linking agent; and
water,
wherein the cloth contains fibers which have hydroxy groups.

2. The dye printing treatment liquid composition according to claim 1,
wherein a content of the polyester resin with respect to a total mass of the treatment liquid composition is 0.5 to 12.5 percent by mass on a solid content basis.

3. The dye printing treatment liquid composition according to claim 1,
wherein the polyester resin includes at least one selected from the group consisting of a hydroxy group, a carboxy group, a sulfonic acid group, and a sodium salt of one of those groups.

4. The dye printing treatment liquid composition according to claim 1,
wherein the cross-linking agent includes at least one group selected from the group consisting of an isocyanate group and an oxazoline group.

5. The dye printing treatment liquid composition according to claim 1,
wherein a mass ratio of the polyester resin to the cross-linking agent (the polyester resin: the cross-linking agent) is 1:0.05 to 1:0.70.

6. A composition set comprising:
the dye printing treatment liquid composition according to claim 1; and
an ink jet ink composition,
wherein the ink jet ink composition contains a dispersive dye and water.

7. A printing method comprising:
a treatment liquid composition adhesion step of adhering the dye printing treatment liquid composition according to claim 1 to the cloth.

8. An ink jet printing method comprising:
a treatment liquid composition adhesion step of adhering the dye printing treatment liquid composition of the composition set according to claim 6 to the cloth;
an ejection step of ejecting the ink jet ink composition of the composition set according to claim 6 from a recording head so as to be adhered to an intermediate transfer medium; and
a transfer step of transferring the ink jet ink composition adhered to the intermediate transfer medium to the cloth to which the dye printing treatment liquid composition is adhered, the cloth being obtained in the treatment liquid composition adhesion step.
